(19) United States
(12) Patent Application Publication
(10) Pub. No.: US 2019/0072804 A1
(43) Pub. Date: Mar. 7, 2019

(54) DISPLAY DEVICE

(71) Applicant: SHARP KABUSHIKI KAISHA, Sakai City, Osaka (JP)

(72) Inventors: RYOHSUKE SUGIYAMA, Sakai City (JP); HIROSHI OKUNO, Sakai City (JP)

(73) Assignee: SHARP KABUSHIKI KAISHA, Sakai City, Osaka (JP)

(21) Appl. No.: 16/081,860

(22) PCT Filed: Feb. 28, 2017
(86) PCT No.: PCT/JP2017/007724

§ 371 Date: Aug. 31, 2018

(30) Foreign Application Priority Data
Mar. 7, 2016 (JP) 2016-043212

(51) Int. Cl. G02F 1/1345; G09F 9/30

(52) U.S. Cl. CPC G02F 1/13452; G02F 1/133305; G09F 9/301

(57) ABSTRACT

A liquid crystal display device 10 includes a curved liquid crystal panel 11 having a curved display surface 11DS on which an image is displayed, a control circuit board 13 disposed on an opposite side from the display surface 11DS with respect to the curved liquid crystal panel 11 and overlapping the curved display panel 11, a liquid crystal panel side flexible board 14 having a first end portion connected to the curved liquid crystal panel 11 and a second end portion protruding from an edge of the curved liquid crystal panel 11, and a board side flexible board 16 having a first end portion connected to the control circuit board 13 and a second end portion protruding from an edge of the control circuit board 13 and connected to the second end portion of the liquid crystal panel side flexible board 14.

### TECHNICAL FIELD

The present invention relates to a display device.

### BACKGROUND ART

A curved liquid crystal display device described in Patent Document 1 below has been known as an example of a curved liquid crystal display device having a curved display surface. In the curved liquid crystal display device in Patent Document 1, a liquid crystal device cell, which includes a polymer film as a base, and a driving circuit board are connected to each other through electrode extraction portions on two ends of a connection board. The connection board has slits between wiring lines. A surface of the liquid crystal device cell is curved through the connection board.

### RELATED ART DOCUMENT

### Patent Document

Patent Document 1: Japanese Unexamined Patent Application Publication No. H3-65925

### Problem to be Solved by the Invention

In the curved liquid crystal display device described in Patent Document 1, the slits formed between the wiring lines on the connection board reduce the stress applied to the connection. However, the connection board, which is connected to the liquid crystal device cell and the driving circuit board, is folded. In this configuration, the slits in the connection board do not always sufficiently reduce the stress applied to the connection and the connection reliability may be insufficient. Furthermore, the slits in the connection board may reduce the strength of the connection board and may cause damage such as a cut to the connection board.

### DISCLOSURE OF THE PRESENT INVENTION

The present invention was made in view of the above-described circumstance and an object thereof is to improve the connection reliability.

### Means for Solving the Problem

A display device according to the invention includes a curved display panel having a curved display surface on which an image is displayed, a board disposed on an opposite side from the curved display surface with respect to the curved display panel and overlapping the curved display panel, a display panel side connection member having a first end portion connected to the curved display panel and a second end portion protruding from an edge of the curved display panel, and a board side connection member having a first end portion connected to the board and a second end portion protruding from an edge of the board and connected to the second end portion of the display panel side connection member.

As described above, the display panel side connection member is connected at the first end portion to the curved display panel having the curved display surface on which an image is displayed and at the second end portion to the second end portion of the board side connection member, which has the first end portion connected to the board. Thus, the board and the display panel are electrically connected to each other. Since the display panel side connection member, which is directly connected to the curved display panel, does not need to be folded, stress is unlikely to be applied to the connection between the curved display panel and the display panel side connection member. This improves the connection reliability of the display panel side connection member to the curved display panel. Furthermore, since the display panel side connection member does not need to have slits, which are included in the conventional configuration, the display panel side connection member is unlikely to have unexpected damage caused by slits.

The following configurations are preferable as aspects of the present invention.

(1) The display device may include an anisotropic conductive film between the second end portion of the display panel side connection member and the second end portion of the board side connection member. With this configuration, the second end portion of the display panel side connection member and the second end portion of the board side connection member are electrically connected to each other through the anisotropic conductive film. The production cost related to the connection members is low compared with a configuration in which connectors fitted together are disposed on the respective flexible boards.

(2) The display device may include a display panel side connector disposed on the second end portion of the display panel side connection member and a board side connector disposed on the second end portion of the board side connection member and fitted to the display panel side connector. A gap equal to or larger than the thickness of the curved liquid crystal panel is provided between the second end portion of the display panel side connection member and the second end portion of the board side connection member. Since the display panel side connector and the board side connector fitted together are interposed between the second end portion of the display side connection member and the second end portion of the board side connection member, i.e., disposed to fill the gap, deformation of the display panel side connection member and the board side connection member possibly caused by the gap is reduced or eliminated. In this configuration, stress is unlikely to be applied to the connection between the curved display panel and the display panel side connection member.

### Advantageous Effect of the Invention

The present invention improves the connection reliability.

### BRIEF DESCRIPTION OF THE DRAWINGS

FIG. 1 is a schematic perspective view illustrating a liquid crystal display device according to a first embodiment of the invention before flexible boards are connected to each other.

FIG. 2 is a schematic side view illustrating the liquid crystal display device before the flexible boards are connected to each other.

FIG. 3 is a schematic, side view illustrating the liquid crystal display device after the flexible boards are connected to each other.

FIG. 4 is a schematic side view illustrating a liquid crystal display device according to a second embodiment of the invention before the flexible boards are connected to each other.

FIG. 5 is a schematic side view illustrating the liquid crystal display device after: the flexible boards are connected to each other.

### MODE FOR CARRYING OUT THE INVENTION

### First Embodiment

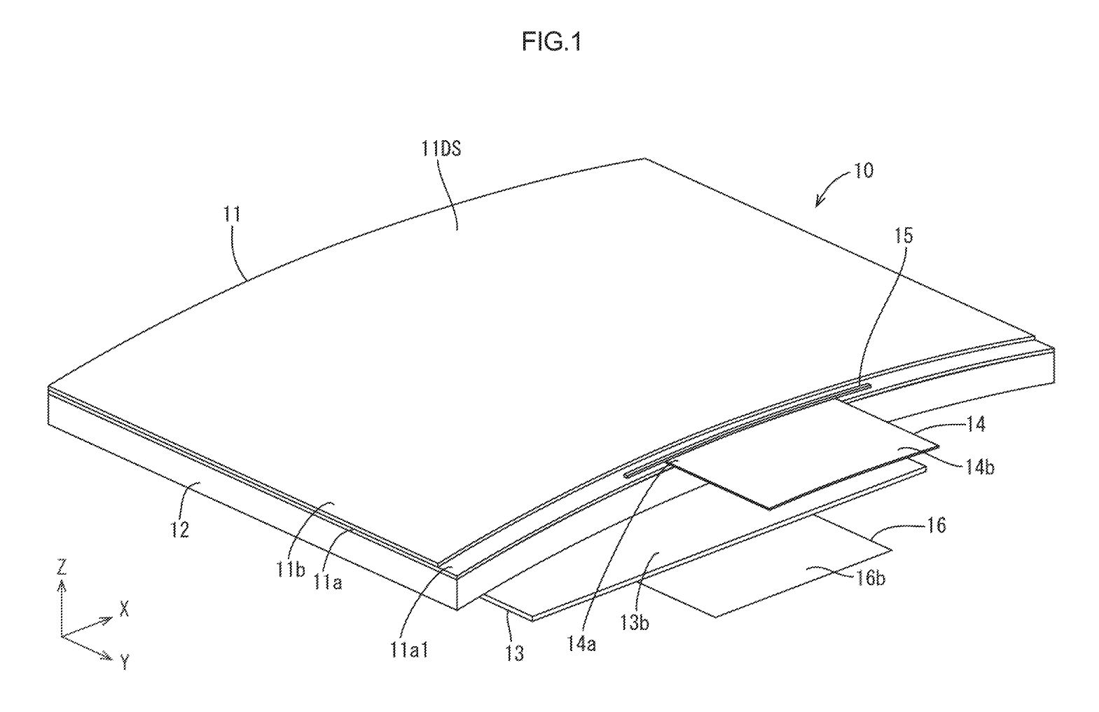

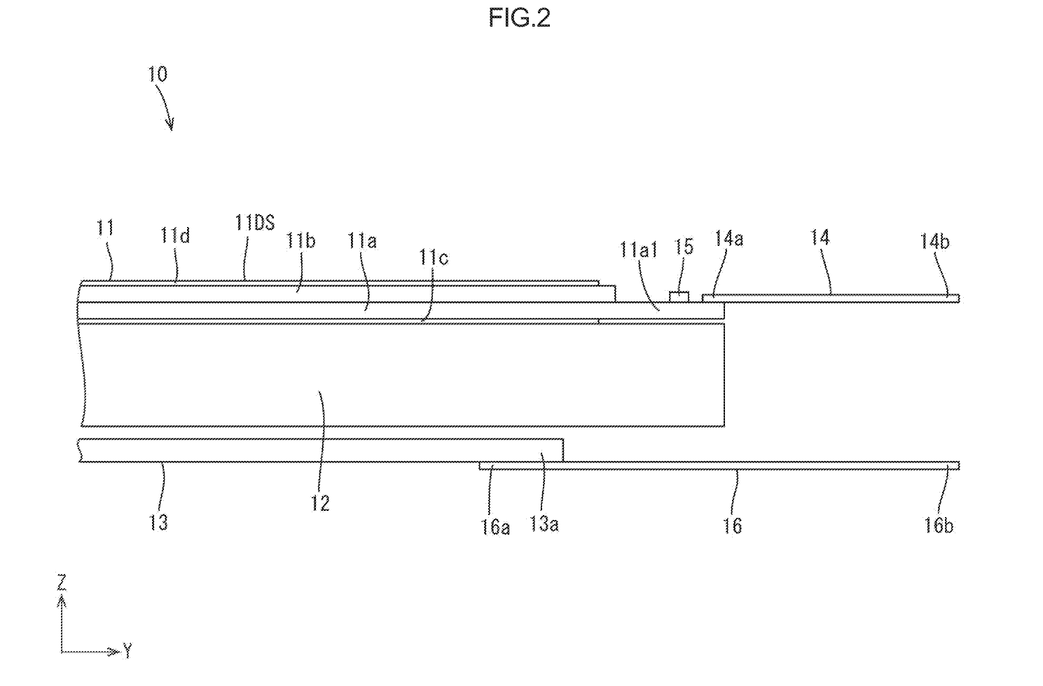

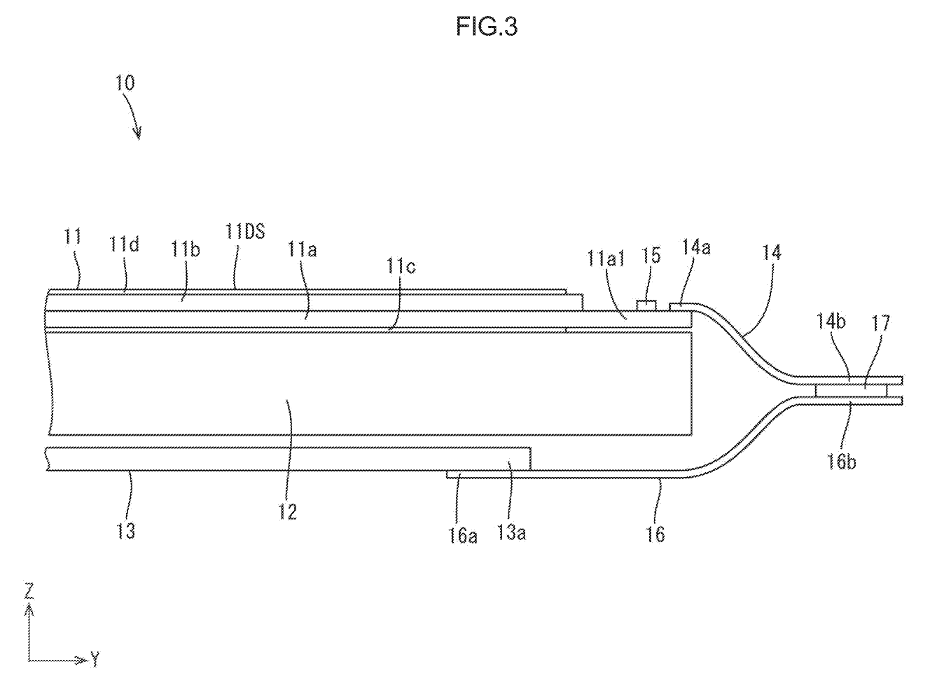

A first embodiment of the invention, is described with reference to FIGS. 1 to 3. In this embodiment, a liquid, crystal display device 10 is described as an example. The X axis, Y axis, and Z axis are indicated in some of the drawings, and each of the axes indicates the same direction in the respective drawings. The up and down direction is based on that of FIGS. 2 and 3, and the upper side in FIGS. 2 and 3 is a front side and the lower side in FIGS. 2 and 3 is a rear side.

As illustrated in FIG. 1, the liquid crystal display device 10 at least includes a curved liquid crystal panel (curved display panel) 11 having a curved display surface 11DS on which an image is displayed, a backlight unit (lighting unit) 12 as an external light source configured to apply light for displaying to the curved liquid crystal panel 11, and a control circuit board (control board, signal supply source) 13 configured to supply various signals from an external device to the curved liquid crystal panel 11. A liquid crystal panel side flexible board (display panel side connection member) 14 and a driver 15 are electrically connected to the curved liquid crystal panel 11. A board side flexible board (board side connection member) 16 is electrically connected to the control circuit board 13. The liquid crystal display device 10 according to the embodiment is preferably used as an in-vehicle device, such as a car navigation system. The screen size of the curved liquid crystal panel 11 is preferably in a range of about 5 inches to about 13 inches.

As illustrated in FIG. 1, the curved liquid crystal panel 11 has a horizontally-long quadrilateral (rectangular, elongated) overall shape and is curved into a substantially arc with the middle in the long side direction up, toward the front side, and the ends in the long side direction down, toward the rear side. The curved liquid crystal panel 11 preferably has a radius of curvature of about 500 mm to about 1500 mm. The short side direction, the long side direction, and the thickness direction of the curved liquid crystal panel 11 respectively match the Y-axis direction, the X-axis direction, and the Z-axis direction in the drawings. As illustrated in FIG. 2, the curved liquid crystal panel 11 includes two substantially transparent glass substrates 11a and 11b bonded together with a predetermined gap therebetween. Liquid crystals are sealed between the substrates 11a and 11b. One of the substrates 11a and 11b that is on the rear side is an array substrate 11a and the other on the front side is a CF substrate 11b. On the array substrate 11a, switching devices (for example, TFTs) connected to source lines and gate lines, which are perpendicular to each other, pixel electrodes connected to the switching devices, and an alignment film, for example, are disposed. On the CF substrate 11b, components such as color filters having R (red), G (green), and B (blue) color portions, for example, in a predetermined arrangement, a counter electrode, and an alignment film are disposed. The array substrate 11a has a long side longer than that of the CF substrate 11b. The CF substrate lib is bonded to the array substrate 11a with one end portion extending in the long side direction being aligned with that of the array substrate 11a. Thus, the other end portion of the array substrate 11a protrudes outwardly from the other end portion of the CF substrate 11b. The liquid crystal panel side flexible board 14 and the driver 15 are disposed on the protruded portion (non-display area) 11a1. Terminals (not illustrated) connected to the liquid crystal panel side flexible board 14 and the driver 15 are disposed on the protruded portion 11aof the array substrate 11a. Front and rear polarizing plates 11c are bonded to the respective outer surfaces of the substrates 11a and 11b.

As illustrated in FIG. 1, the backlight unit 12 has a horizontally-long quadrilateral overall shape and is disposed over the rear surface (surface opposite the display surface 11DS) of the curved liquid crystal panel 11 while being curved along the curved liquid crystal panel 11. The backlight unit 12 illustrated in FIG. 2 at least includes a light source (not illustrated) (such as an LED and an organic EL) and an optical member (not illustrated). The optical member has a function of converting light emitted by the light source into a planar light.

As illustrated in FIGS. 1 and 2, the control circuit board 13 is disposed on the rear surface (outer surface away from the curved liquid crystal panel 11) of the backlight unit 12 and overlaps the curved liquid crystal panel 11 and the backlight unit 12 in plan view. The control circuit board 13 includes a paper phenol substrate or a glass epoxy resin substrate on which an electronic component configured to supply various signals to the driver 15 is disposed and a wiring line (conductive path) having a predetermined pattern is routed. A portion of the wiring line exposed at an end portion 13a of the control circuit board 13 is used as a terminal (not illustrated).

As illustrated in FIGS. 1 and 2, the driver 15 is directly mounted, i.e., mounted by using a chip on glass (COG) technology, on the protruded portion 11a1 of the array substrate 11a included in the curved liquid crystal panel 11. The driver 15 includes an LSI chip having a driving circuit therein. The driver 15 is configured to process input signals supplied by the control circuit board 13, which is a signal supply source, to generate output signals and output the output signals to the switching device of the curved liquid crystal panel 11.

Next, the liquid crystal panel side flexible board 14 and the board side flexible board 16 are described. The configuration common to them is described first. As illustrated in FIG. 1, the flexible boards 14 and 16 each include a film-like base formed of an insulating and flexible synthetic resin material (such as polyimide resin) and a wiring pattern (not illustrated) having multiple wiring lines on the base. Portions of the wiring pattern are exposed at end portions 14a, 14b, 16a, and 16b of the flexible boards 14 and 16 and used as terminals (not illustrated). The flexible boards 14 and 16 each preferably have a width of about 40 mm to about 50 mm. The number of wiring lines in the wiring pattern is preferably about 200.

As illustrated in FIGS. 1 and 2, the first end portion 14a of the liquid crystal panel side flexible board 14 is disposed on the protruded portion 11a1 of the array substrate 11a included in the curved liquid crystal panel 11. The first end portion of the liquid crystal panel side flexible board 14 is curved along the curved liquid crystal panel 11 with a radius of curvature substantially equal to that of the curved liquid crystal panel 11. The terminal on the first end portion 14a of the liquid crystal panel side flexible board 14 and the terminal on the protruded portion 11a1 of the array substrate 11a are electrically and mechanically connected to each other through an anisotropic conductive film (ACF) (not illustrated).

As illustrated in FIGS. 1 and 2, the first end portion 16a of the board side flexible board 16 is attached to the end portion 13a of the control circuit board 13. The terminal on the first end portion 16a of the board side flexible board 16 and the terminal on the end portion 13a of the control circuit board 13 are electrically and mechanically connected to each other through an anisotropic conductive film (not illustrated).

As illustrated in FIG. 2, the flexible boards 14 and 16 are disposed such that the second end portions 14b and 16b, which are located away from the connection targets, i.e., the curved liquid crystal panel 11 and the control circuit board 13, protrude outwardly in the Y-axis direction, from the respective edges of the curved liquid crystal panel 11 and the control circuit board 13. Portions of the flexible boards 14 and 16 that, protrude outwardly from the protruded portion 11a1 of the curved liquid crystal panel 11 and the end portion 13a of the control circuit board 13 do not overlap the curved liquid crystal panel 11, the backlight unit 12, and the control circuit board 13 in plan view. As illustrated in FIG. 3, the second end portion 14b of the liquid crystal panel side flexible board 14 (end portion away from the curved liquid crystal panel 11) and the second end portion 16b of the board side flexible board 16 (end portion away from the control circuit board 13) are electrically and mechanically connected to each other through an anisotropic conductive film 17. The terminals on the second end portions 14b and 16b of the flexible boards 14 and 16 are in conductive connection through conductive particles in the anisotropic conductive film 17, allowing signals, for example, to be transmitted from the control circuit board 13 to the curved liquid crystal panel 11. The portion of the liquid crystal panel side flexible board 14 protruding from the curved liquid crystal panel 11 has such a length that allows the second end portion 14b to remain flat without being affected by the curved first end portion 14a. The portion of the board side flexible board 16 protruding from the control circuit board 13 has a length corresponding to the length of the protruded portion of the liquid crystal panel side flexible board 14. Since a gap substantially equal to the total thickness of the curved liquid crystal panel 11, the backlight unit 12, and the control circuit board 13 is provided between the second end portions 14b and 16b of the flexible boards 14 and 16, the flexible boards 14 and 16 are gently curved such that the second end portions 14b and 16b come closer to each other in the Z-axis direction, but the flexible boards 14 and 16 are not folded.

In this configuration, since the liquid crystal panel side flexible board 14, which is directly connected to the curved liquid crystal panel 11, does not need to be folded, stress is unlikely to be applied to the connection between the curved liquid crystal panel 11 and the liquid crystal panel side flexible board 14. This improves the connection reliability of the liquid crystal panel side flexible board 14 to the curved liquid crystal panel 11. Furthermore, since the liquid crystal panel side flexible board 14 does not need to have slits, which are included in the conventional configuration, the liquid crystal panel side flexible board 14 is unlikely to have unexpected damage caused by slits. Furthermore, since the second end portion 14b of the liquid crystal panel side flexible board 14 and the second end portion 16b of the board side flexible board 16 are electrically connected to each other through the anisotropic conductive film 17, the production cost related to the flexible boards 14 and 16 is low compared with a configuration in which connectors fitted together are disposed on the respective flexible boards.

As described above, the liquid crystal display device (display device) 10 according to the embodiment includes the curved liquid crystal panel (curved display panel) 11 having the curved display surface 11DS on which an image is displayed, the control circuit board (board) 13 disposed over the surface of the curved liquid crystal panel 11 opposite the display surface 11DS, the liquid crystal panel side flexible board (display panel side connection member) 14 having the first end portion connected to the curved liquid crystal panel 11 and the second end portion protruding from the edge of the curved liquid crystal panel 11, and the board side flexible board (board side connection member) 16 having the first end portion connected to the control circuit board 13 and the second end portion protruding from the edge of the control circuit board 13 and connected to the second end portion of the liquid crystal panel side flexible board 14.

As described above, the liquid crystal panel side flexible board 14 is connected at the first end portion to the curved liquid crystal panel 11 having the curved display surface 11DS on which an image is displayed and at the second end portion to the second end portion of the board side flexible board 16, which has the first end portion connected to the control circuit board 13. Thus, the control circuit board 13 and the display panel are electrically connected to each other. Since the liquid crystal panel side flexible board 14, which is directly connected to the curved liquid crystal panel 11, does not need to be folded, stress is unlikely to be applied to the connection between the curved liquid crystal panel 11 and the liquid crystal panel side flexible board 14. This improves the connection reliability of the liquid crystal panel side flexible board 14 to the curved liquid crystal panel 11. Furthermore, since the liquid crystal panel side flexible board 14 does not need to have slits, which are included in the conventional configuration, the liquid crystal panel side flexible board 14 is unlikely to have unexpected damage caused by slits.

Furthermore, the liquid crystal display device 10 includes the anisotropic conductive film 17 between the second end portion of the liquid crystal panel side flexible board 14 and the second end portion of the board side flexible board 16. With this configuration, the second end portion of the liquid crystal panel side flexible board 14 and the second end portion of the board side flexible board 16 are electrically connected to each other through the anisotropic conductive film 17. The production cost related to the flexible boards 14 and 16 is low compared with a configuration in which connectors fitted together are disposed on the respective flexible boards.

### Second Embodiment

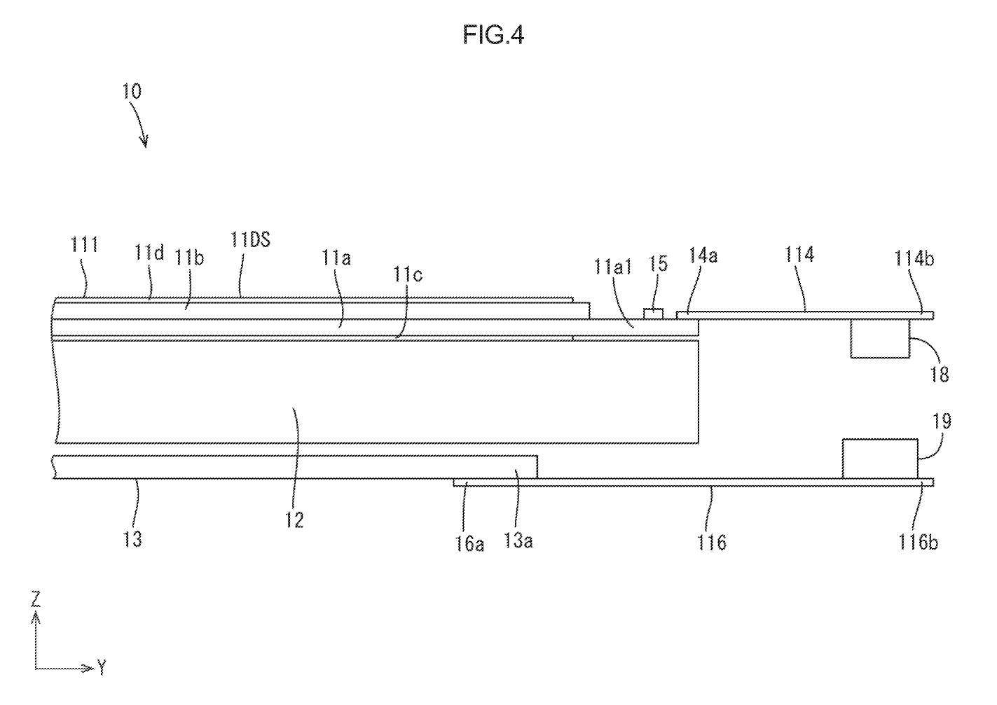

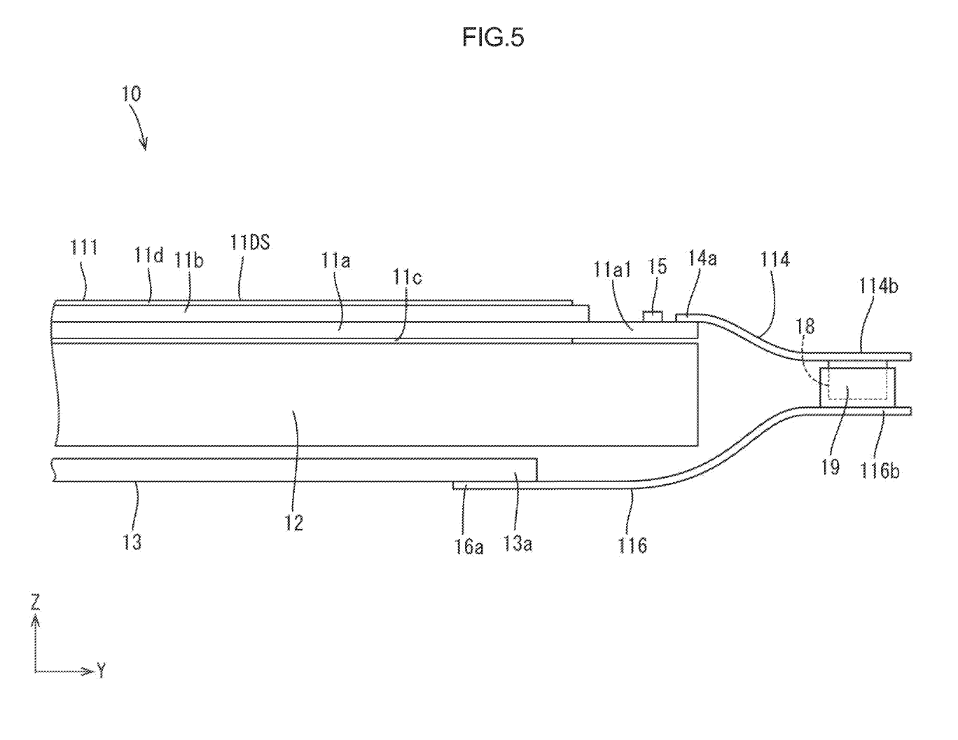

A second embodiment of the invention is described with reference to FIG. 4 or FIG. 5. In the second embodiment, flexible boards 114 and 116 are connected to each other in a different way. Configurations, operations, and effects similar to those of the first embodiment are not described.

As illustrated in FIGS. 4 and 5, the flexible boards 114 and 116 according to this embodiment have connectors 18 and 19 configured to be fitted together. Specifically described, a liquid crystal panel side connector (display panel side connector) 18 is disposed on the second end portion 114b of the liquid crystal panel side flexible board 114 and a board side connector 19 configured to be fitted to the liquid crystal panel side connector 18 is disposed on a second end portion 116b of the board side flexible board 116. The liquid crystal panel side connector 18 is disposed on the rear surface (surface adjacent to the board side flexible board 116) of the second end portion 114b of the liquid crystal panel side flexible board 114. The board side connector 19 is disposed on the front surface (surface adjacent to the liquid crystal panel side flexible board 114) of the second end portion 116b of the board side flexible board 116. The board side connector 19 has a recessed shape capable of receiving the entire liquid crystal panel side connector 18. Conversely, the liquid crystal panel side connector 18 has a convex shape capable of fitting in the board side connector 19.

As described above, the liquid crystal panel side connector 18 and the board side connector 19 are sandwiched (interposed) between the second end portion 114b of the liquid crystal panel side; flexible board 114 and the second end portion 116b of the board side flexible board 116 in the Z-axis direction, i.e., are disposed to fill the gap between the end portions 114b and 116b. This configuration reduces deformation of the liquid crystal panel side flexible board 114 and the board side flexible board 116 possibly caused by the gap. Thus, stress is unlikely to be applied to the connection between the curved liquid crystal panel 111 and the liquid crystal panel side flexible board 114. In this embodiment, the total of the height of the liquid crystal panel side connector 18 and the height of the board side connector 19 is smaller than the gap between the flexible boards 114 and 116. Thus, the flexible boards 114 and 116 are slightly deformed to come close to each other in the Z-axis direction. The amount of deformation is smaller than that in the first embodiment.

As described above, this embodiment includes the liquid crystal panel side connector (display panel side connector) 18 disposed on the second end portion of the liquid crystal panel side flexible board 114 and the board side connector 19 disposed on the second end portion of the board side flexible board 116 and fitted to the liquid crystal panel side connector 18. A gap equal to or larger than the thickness of the curved liquid crystal panel 111 is provided between the second end portion of the liquid crystal panel side flexible board 114 and the second end portion of the board side flexible board 116. Since the liquid crystal panel side connector 18 and the board side connector 19 fitted together are interposed between the second end portion of the liquid crystal panel side flexible board 114 and the second end portion of the board side flexible board 116, i.e., disposed to fill the gap, deformation of the liquid crystal panel side flexible board 114 and the board side flexible board 116 possibly caused by the gap is reduced or eliminated. In this configuration, stress is unlikely to be applied to the connection between the curved liquid crystal panel 111 and the liquid crystal panel side flexible board 114.

### Other Embodiments

The present invention is not limited to the embodiments described above and illustrated by the drawings. For example, the following embodiments will be included in the technical scope of the present invention.

(1) In the above-described embodiments, the screen size of the curved liquid crystal panel is in a range of about 5 inches to about 13 inches. However, the screen size of the curved liquid crystal panel may fall outside the above range (may be smaller than 5 inches or larger than 13 inches).

(2) In the above-described embodiments, the curved liquid crystal panel has a radius of curvature of about 500 mm to about 1500 mm. However, the radius of curvature of the curved liquid crystal panel may fall outside the above range (may be smaller than 500 mm or larger than 1500 mm).

(3) In the above-described embodiments, the flexible board has a width of about 40 mm to about 50 mm. However, the width of the flexible board may fall outside the range (may be smaller than 40 mm or larger than 50 mm).

(4) In the above-described embodiments, the number of wiring lines on the flexible board is about 200. However, the number of wiring lines on the flexible board is not limited to 200 (may be smaller than 200 or larger than 200).

(5) As a modification of the second embodiment, the height of the connectors fitted together may be equal to or larger than the gap between the flexible boards that are kept straight. The height equal to the gap is most preferable to reduce stress applied to the connection between the curved liquid crystal panel and the liquid crystal panel side flexible board because the flexible boards hardly deform while the connectors are fitted together.

(6) In the above-described embodiments, the curved liquid crystal panel is curved into a substantially arc with the middle in the long side direction up, toward the front side, and the ends in the long side direction down, toward the rear side. However, the curved liquid crystal panel may be curved in an arc with the middle in the long side direction down, toward the rear side, and the ends in the long side direction up, toward the front side. Alternatively, the curved liquid crystal panel may be curved in a substantially arc with the middle in the short side direction up, toward the front side (or down toward the rear side) and the ends in the short side direction down, toward the rear side (or up toward the front side).

(7) In the above-described embodiments, the number of the liquid crystal panel side flexible board and the number of the board side flexible board are one. However, the number of the liquid crystal panel side flexible board and the number of the board side flexible board may be two or more.

(8) In the above-described embodiments, the control circuit board has a flat planar shape and is not curved along the curved liquid crystal panel or the curved backlight unit. However, the control circuit board may be curved along the curved liquid crystal panel or the curved backlight unit. In such a case, stress is unlikely to be applied to the connection between the board side flexible board and the control board. This improves the connection reliability between the board side flexible board and the control board.

(9) In the above-described embodiments, the substrates of the curved liquid crystal panel are each formed of a glass material. However, the material of the substrates of the curved liquid crystal panel may be a synthetic resin material.

(10) In the above-described embodiments, the driver is mounted on the array substrate by using COG technology. However, the driver may be mounted on the liquid crystal panel side flexible board by using chip on film (COF) technology.

(11) In the above-described embodiments, the liquid crystal display device includes the curved liquid crystal panel having an oblong planar shape. However, the present invention is also applicable to a liquid crystal display device including a curved liquid crystal panel having a square, circular, or elliptical planar shape.

(12) In the above-described embodiments, the curved liquid crystal panel includes the liquid crystal layer between two substrates. However, the present invention is also applicable to a curved display panel including functional organic molecules other than the liquid crystal material between two substrates.

(13) In the above-described embodiments, the TFTs are used as the switching devices of the curved liquid crystal panel. However, the invention is also applicable to a curved liquid crystal panel including switching devices other than the TFTs (e.g., thin film diodes (TFDs)). The invention is also applicable to a black-and-white liquid crystal panel other than the color-liquid crystal panel.

(14) In the above-described embodiments, the liquid crystal display device is a transmissive liquid crystal display device including a backlight unit as an external light source. However, the present invention is also applicable to a reflective liquid crystal display device configured to provide a display by using outside light. In such a case, a backlight unit may be eliminated. Furthermore, the present invention is also applicable to a semi-transmissive liquid crystal display device.

(15) In the above-described embodiments, the curved liquid crystal panel is used as a display panel. However, the invention is also applicable to other types of display panels, such as a plasma display panel (PDP), an organic EL panel, an electrophoretic display panel (EPD), and a micro electro mechanical system (MEMS).

(16) In the above-described embodiments, the liquid crystal display device is an in-vehicle liquid crystal display device. However, the present invention is also applicable to a liquid crystal display device mounted in a vehicle other than a passenger-car (such as a motorcycle and a tractor) or to a liquid crystal display device mounted in a transport machine other than the vehicle (such as an airplane, a helicopter, and a ship). Furthermore, other than the liquid crystal display device mounted in the transport machine, the present invention is applicable to a liquid crystal display device used in a smart phone, a tablet computer, a game player, a laptop computer, a desktop computer, or a television receiver, for example.

### EXPLANATION OF SYMBOLS

10 . . . liquid crystal display device (display device), 11, 111 . . . liquid crystal panel (display panel), 11DS . . . display surface, 12 . . . backlight unit (lighting unit), 13 . . . control circuit board (board), 13a . . . end portion, 14, 114 . . . liquid crystal panel side flexible board (display panel side connection member), 16, 116 . . . board side flexible board (board side connection member), 17 . . . anisotropic conductive film, 18 . . . liquid crystal panel side connector (display panel side connector), 19 . . . board side connector

1. A display device comprising:
a curved display panel having a curved display surface on which an image is displayed;
a board disposed on an opposite side from the curved display surface with respect to the curved display panel and overlapping the curved display panel;
a display panel side connection member having a first end portion connected to the curved display panel and a second end portion protruding from an edge of the curved, display panel; and
a board side connection member having a first end portion connected to the board and a second end portion protruding from an edge of the board and connected to the second end portion of the display panel side connection member.

2. The display device according to claim 1, further comprising an anisotropic conductive film between the second end portion of the display panel side connection member and the second end portion of the board side connection member.

3. The display device according to claim 1, further comprising:
a display panel side connector disposed on the second end portion of the display panel side connection member; and
a board side connector disposed on the second end portion of the board side connection member and fitted to the display panel side connector.
